(19) United States
(12) Patent Application Publication
(10) Pub. No.: US 2009/0058793 A1
(43) Pub. Date: Mar. 5, 2009

(54) BACKLIGHT UNIT FOR SYNCHRONIZATION WITH AN IMAGE SIGNAL FOR LIQUID CRYSTAL DISPLAY

(75) Inventors: Sang Cheol SHIN, Pyeongtaek (KR); Byoung Own MIN, Suwon (KR); Jung Chul GONG, Seoul (KR); Yu Jin JANG, Suwon (KR); Seung Kon KONG, Gwangmyeong (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD

(21) Appl. No.: 12/199,344

(22) Filed: Aug. 27, 2008

(30) Foreign Application Priority Data
Aug. 27, 2007 (KR) 10-2007-0085978

(51) Int. Cl. G09G 3/36

(52) U.S. Cl. 345/102

(57) ABSTRACT

A backlight unit for synchronization with an image signal for a liquid crystal display (LCD), which can synchronize frequencies of a lamp driving signal and a lamp brightness signal with frequencies of a horizontal synchronization signal and a vertical synchronization signal, which are image signals used in an LCD panel. The backlight unit includes a synchronization part generating a first synchronized signal synchronized with a horizontal synchronization signal having a preset frequency, and a second synchronized signal synchronized with a vertical synchronization signal having a frequency different from the frequency of the horizontal synchronization signal, and a signal generation part generating a lamp driving signal for driving a lamp according to the first synchronized signal and a lamp brightness signal for controlling brightness of the lamp according to the second synchronized signal.

### CROSS-REFERENCE TO RELATED APPLICATIONS

This application claims the priority of Korean Patent Application No. 2007-85978 filed on Aug. 27, 2007, in the Korean Intellectual Property Office, the disclosure of which is incorporated herein by reference.

### BACKGROUND OF THE INVENTION

1. Field of the Invention

The present invention relates to a backlight unit, and more particularly, to a backlight unit for synchronization with an image signal for a liquid crystal display (LCD), which can synchronize frequencies of a lamp driving signal and a lamp brightness signal with frequencies of a horizontal synchronization signal and a vertical synchronization signal, which are image signals used in an LCD panel.

2. Description of the Related Art

Liquid crystal displays (LCDs) are being employed in a variety of display devices for, e.g., monitors and computers because of their slimness and lightness.

An LCD product necessarily employs a backlight unit that turns on a lamp of the LCD to output desired light.

FIG. 1 is a block diagram of a related art backlight unit for an LCD.

Referring to FIG. 1, the related art backlight unit for an LCD includes a lamp driving signal generation part 11, a lamp brightness signal generation part 12 and a lamp driving part 13.

A first reference signal having a preset frequency and a second reference signal having a preset frequency which is different from the preset frequency of the first reference signal are respectively input to the lamp driving signal generation part 11 and the lamp brightness signal generation part 12.

The lamp driving signal generation part 11 sends a lamp driving signal to the lamp driving part 13 according to a frequency of the first reference signal. The lamp brightness signal generation part 12 sends a lamp brightness signal to the lamp driving part 13 according to a frequency of the second reference signal.

The lamp driving part 13 drives a lamp 14 according to the lamp driving signal, and controls brightness of the lamp 14 according to the lamp brightness signal.

An LCD product uses a horizontal synchronization signal and a vertical synchronization signal for an image board. The horizontal synchronization signal and the vertical synchronization signal have different frequencies. The frequency of the horizontal synchronization signal and the frequency of the vertical synchronization signal may interfere with a frequency of the lamp driving signal and a frequency of the lamp brightness signal. The interference undesirably causes a waterfall or flicker phenomenon in the LCD product.

### SUMMARY OF THE INVENTION

An aspect of the present invention provides a backlight unit for synchronization with an image signal for an LCD, which can synchronize frequencies of a lamp driving signal and a lamp brightness signal with frequencies of a horizontal synchronization signal and a vertical synchronization signal, which are image signals used for an LCD panel.

According to an aspect of the present invention, there is provided a backlight unit for synchronization with an image signal for a liquid crystal display (LCD), includes: a synchronization part generating a first synchronized signal synchronized with a horizontal synchronization signal having a preset frequency, and a second synchronized signal synchronized with a vertical synchronization signal having a frequency different from the frequency of the horizontal synchronization signal; and a signal generation part generating a lamp driving signal for driving a lamp according to the first synchronized signal and a lamp brightness signal for controlling brightness of the lamp according to the second synchronized signal.

The synchronization part may include: a first synchronizer generating the first synchronized signal synchronized with the frequency of the horizontal synchronization signal; a frequency converter multiplying and/or dividing the frequency of the vertical synchronization signal; and a second synchronizer generating the second synchronized signal synchronized with a multiplied and/or divided frequency of the vertical synchronization signal from the frequency converter.

The signal generation part may include: a lamp driving signal generator converting a signal waveform of the first synchronized signal according to the frequency of the first synchronized signal to generate the lamp driving signal; and a lamp brightness signal generator converting a signal waveform of the second synchronized signal according to the frequency of the second synchronized signal to generate the lamp brightness signal.

The first synchronizer may include: a first frequency detector comparing the frequency of the horizontal synchronization signal with a preset reference frequency to detect a frequency difference therebetween; a first charging pump charging or discharging a voltage according to the frequency difference from the first frequency detector; a first voltage-current converter converting the charged or discharged voltage from the first charging pump to a current having a preset ratio; and a first oscillator generating the first synchronized signal having a frequency varied according to the current from the first voltage-current converter.

The second synchronizer may include: a second frequency detector comparing a multiplied and/or divided frequency of the vertical synchronization signal with a preset reference frequency to detect a frequency difference therebetween; a second charging pump charging or discharging a voltage according to the frequency difference from the second frequency detector; a second voltage-current converter converting the charged or discharged voltage from the second charging pump to a current having a preset ratio; and a second oscillator generating the second synchronized signal having a frequency varied according to the current from the second voltage-current converter.

The first voltage-current converter may convert the charged or discharged voltage from the first charging pump to a preset current according to a user's selection.

The second voltage-current converter may convert the charged or discharged voltage from the second charging pump to a preset current according to a user's selection.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram of a related art backlight unit;

FIG. 2 is a block diagram of a backlight unit according to an exemplary embodiment of the present invention;

FIG. 3 is a block diagram of a synchronization part of the backlight unit according to the exemplary embodiment of the present invention;

FIG. 4A is a graph showing a lamp driving signal synchronized with a horizontal synchronization signal; and

FIG. 4B is a graph showing a lamp brightness signal synchronized with a vertical synchronization signal.

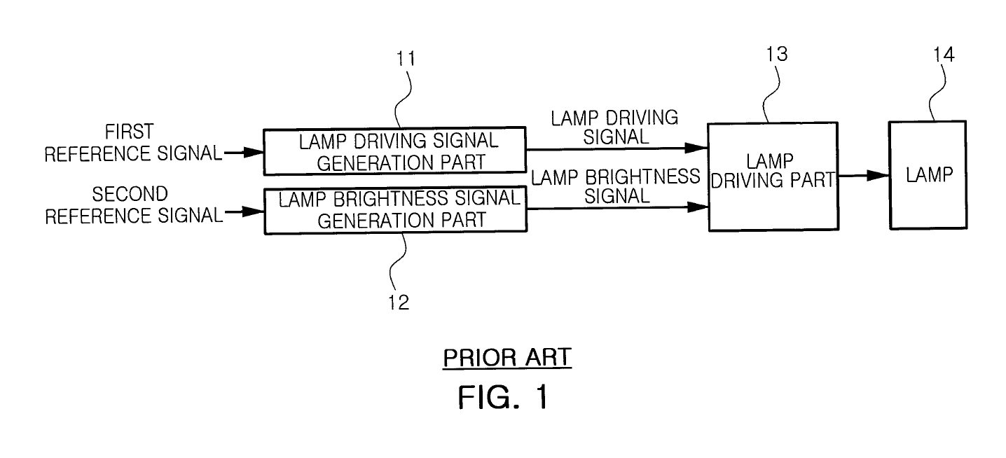

### DETAILED DESCRIPTION OF THE PREFERRED EMBODIMENT

Exemplary embodiments of the present invention will now be described in detail with reference to the accompanying drawings.

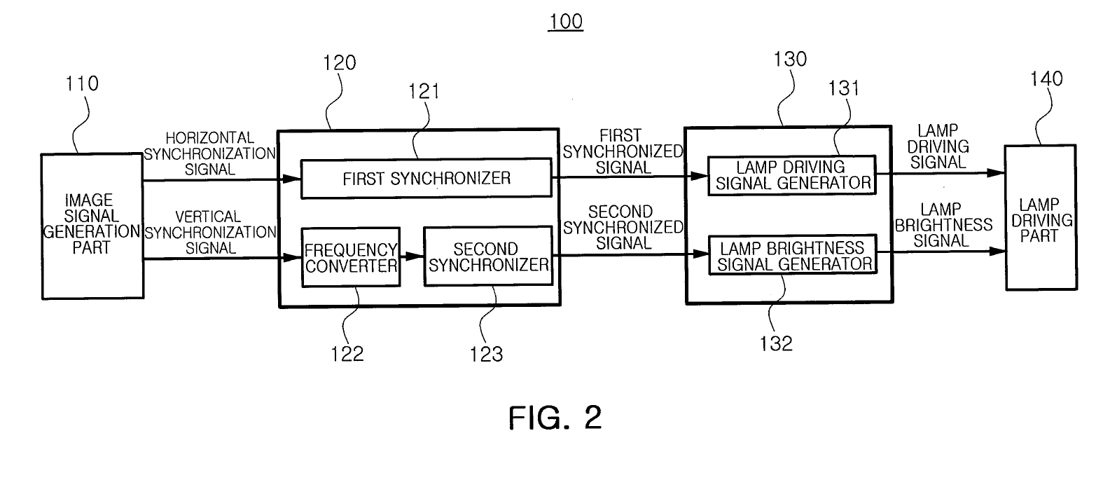

FIG. 2 is a block diagram of a backlight unit according to an exemplary embodiment of the present invention.

Referring to FIG. 2, a backlight unit 100 according to the current embodiment may include an image signal generation part 110, a synchronization part 120, a signal generation part 130, and a lamp driving part 140.

The image signal generation part 110 generates a horizontal synchronization signal and a vertical synchronization signal driving an image board of an LCD product.

The horizontal synchronization signal has a preset frequency, and the vertical synchronization signal has a preset frequency. The preset frequency of the vertical synchronization signal is different from the preset frequency of the horizontal synchronization signal.

For example, the horizontal synchronization signal may have a frequency of about tens of KHz, and the vertical synchronization signal may have a frequency of about hundreds of Hz.

The synchronization part 120 generates a first synchronized signal and a second synchronized signal respectively synchronized with the frequency of the horizontal synchronization signal and the frequency of the vertical synchronization signal.

The synchronization part 120 includes a first synchronizer 121 generating the first synchronized signal synchronized with the frequency of the horizontal synchronization signal, and a second synchronizer 123 generating a second synchronized signal synchronized with the frequency of the vertical synchronization signal.

The synchronization part 120 further includes a frequency converter 122 converting the frequency of the vertical synchronization signal.

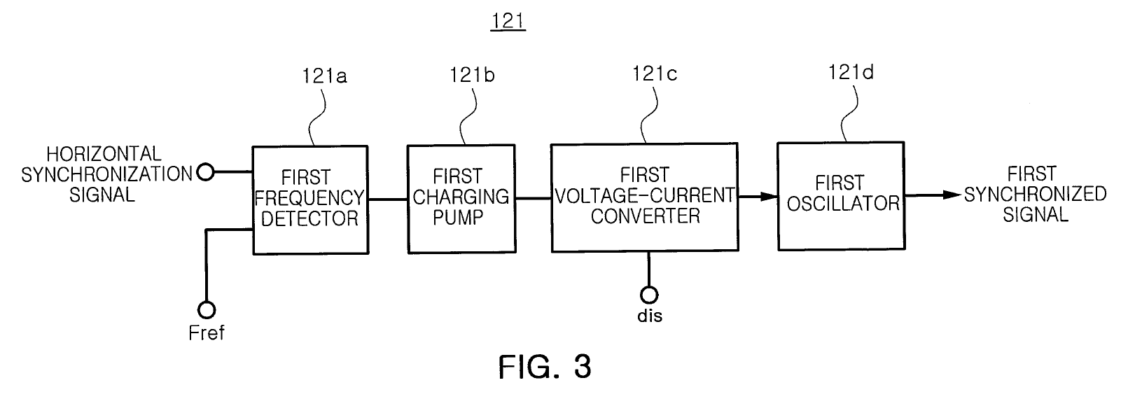

The first synchronizer 121 and the second synchronizer 123 of the synchronization part 120 have identical internal configurations. This will now be described in more detail with reference to FIG. 3.

FIG. 3 is a block diagram of the synchronization part of the backlight unit according to the exemplary embodiment of the present invention.

Referring to FIG. 3, the first synchronizer 121 of the synchronization part 120 employed in the backlight unit according to the current embodiment includes a first frequency detector 121a, a first charging pump 121b, a first voltage-current converter 121c, and a first oscillator 121d.

The first frequency detector 121a compares the frequency of the horizontal synchronization signal with a preset reference frequency Fref to detect a frequency difference therebetween.

The first charging pump 121b charges or discharges a voltage according to the frequency difference from the first frequency detector 121a.

The first voltage-current converter 121c converts a voltage charged or discharged at the first charging pump 121b to a current having a preset ratio.

The first oscillator 121d generates the first synchronized signal having a frequency varied according to the current from the first voltage-current converter 121c.

The detailed configuration of the first synchronizer including the first frequency detector 121a, the first charging pump 121b, the first voltage-current converter 121c and the first oscillator 121d is the same as that of the second synchronizer 123. Therefore, the description of the detailed configuration of the second synchronizer 123 is omitted.

Referring to FIG. 2 again, the backlight unit 100 according to the current embodiment includes the signal generation part 130. The signal generation part 130 includes a lamp driving signal generator 131 generating a lamp driving signal according to a frequency of the first synchronized signal, and a lamp brightness signal generator 132 generating a lamp brightness signal according to a frequency of the second synchronized signal.

The lamp driving signal and the lamp brightness signal from the signal generation part 130 are sent to the lamp driving part 140. The lamp driving part 140 controls driving of a lamp according to the lamp driving signal, and controls brightness of the lamp according to the lamp brightness signal.

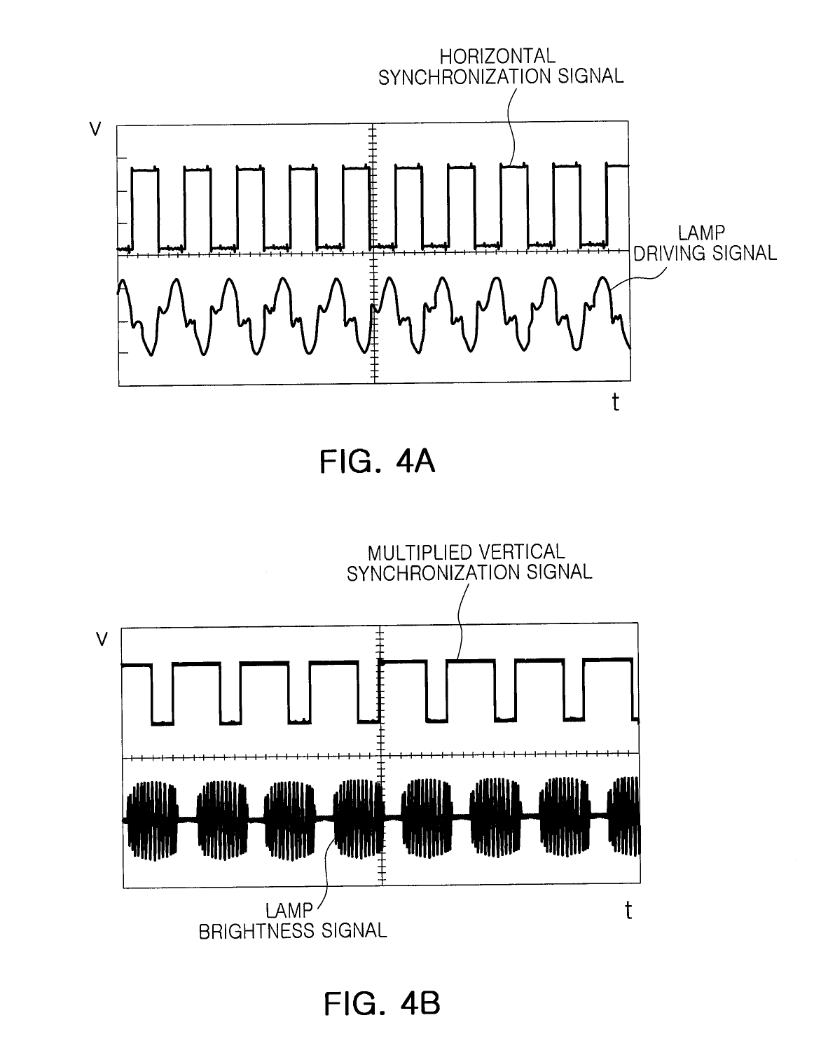

FIG. 4A is a graph showing a lamp driving signal synchronized with a horizontal synchronization signal, and FIG. 4B is a graph showing a lamp brightness signal synchronized with a vertical synchronization signal.

Referring to FIG. 4A, it can be seen that the backlight unit according to the current embodiment synchronizes a frequency of the horizontal synchronization signal with a frequency of the lamp driving signal. Referring to FIG. 4B, it can be seen that the backlight unit according to the current embodiment converts a frequency of the vertical synchronization signal and synchronizes a frequency of the lamp brightness signal with the converted frequency.

Effects and operations of the present invention will now be described with reference to accompanying drawings in more detail.

Referring to FIGS. 2 and 3, the backlight unit 100 according to the current embodiment receives a horizontal synchronization signal and a vertical synchronization signal from the image signal generation part 110. The horizontal synchronization signal and the vertical synchronization signal have different frequencies. The first synchronized signal and the second synchronized signal respectively synchronized with the horizontal synchronization signal and the vertical synchronization signal having different frequencies are generated through the synchronization part 120.

The synchronization part 120 generates the first synchronized signal synchronized with the frequency of the horizontal synchronization signal through the first synchronizer 121. The synchronization part 120 generates the second synchronized signal synchronized with the frequency of the vertical synchronization signal through the second synchronizer 123.

To prevent the waterfall and flicker phenomena of an LCD product, the frequency of the lamp driving signal must be synchronized identically with the frequency of the horizontal synchronization signal. Also, the frequency of the lamp brightness signal must be synchronized alternately with the frequency of the vertical synchronization signal.

Thus, the synchronization part 120 includes the frequency converter 122.

The frequency converter 122 converts the frequency of the vertical synchronization signal into a preset frequency. To convert the frequency of the vertical synchronization signal, the frequency converter 122 multiples and/or divides the frequency of the vertical synchronization signal. That is, the frequency converter 122 converts the frequency of the vertical synchronization signal by multiplying and/or dividing the frequency of the vertical synchronization signal. Accordingly, the frequency of the lamp brightness signal is synchronized with the second synchronized signal, so that the frequency of the lamp brightness signal is alternately synchronized with the frequency of the vertical synchronization signal.

The synchronization part 120 generates the first synchronized signal and the second synchronized signal respectively synchronized with the horizontal synchronization signal and the vertical synchronization signal through the first synchronizer 121 and the second synchronizer 123.

In more detail, the first frequency detector 121a of the first synchronizer 121 compares the frequency of the horizontal synchronization signal with a preset reference frequency Fref to detect a frequency difference therebetween. The first charging pump 121b increases or decreases a voltage being charged or discharged, according to the frequency difference.

The first voltage-current converter 121c converts a charged or discharged voltage from the first charging pump 121b to a current having a preset ratio. The first oscillator 121d generates the first synchronized signal having a frequency varied according to the current.

Accordingly, even if the frequency of the horizontal synchronization signal is changed because of environmental causes, the frequency of the first synchronized signal can be synchronized with the frequency of horizontal synchronization signal.

Although not shown, the detailed configuration of the second synchronizer 123 is identical to that of the first synchronizer 121, except that a second frequency detector (not shown) of the second synchronizer 123 compares a converted frequency of the vertical synchronization signal with a preset reference frequency to detect a frequency difference therebetween.

Of course, the reference frequency Fref input to the first frequency detector 121a is different from the reference frequency input to the second frequency detector (not shown). This is because the frequency of the horizontal synchronization signal is different from the frequency of the vertical synchronization signal

Also, during an abnormal operation of the lamp or a striking mode for initial driving of the lamp, there is no need to synchronize the frequency of the lamp driving signal with the frequency of the horizontal synchronization signal. For this reason, the first voltage-current converter 121c includes a disable terminal dis. A control signal is received through the disable terminal dis in the abnormal operation or the striking mode, so that a preset current can be supplied to the first oscillator 121d regardless of changes in voltage of the first charging pump 121b. Accordingly, the first oscillator 121d can generate the first synchronized signal having a preset frequency.

In the abnormal operation or the striking mode of the lamp, the first voltage-current converter 121c and the first oscillator 121d operate in the same manner as a second voltage-current converter (not shown) and a second oscillator (not shown) of the second synchronizer 123. Thus, in such circumstances, the second synchronizer 123 can generate a second synchronized signal having a preset frequency.

The first synchronized signal and the second synchronized signal are separately input to the signal generation part 130.

The signal generation part 130 includes a lamp driving signal generator 131 and the lamp brightness signal generator 132. The lamp driving signal generator 131 generates a lamp driving signal according to the frequency of the first synchronized signal. The lamp brightness signal generator 132 generates a lamp brightness signal according to the frequency of the second synchronized signal.

For example, the first and second synchronized signals may each have a signal form of a chopping-wave or a sine-wave. The lamp driving signal generator 131 may generate a lamp driving signal having a signal form similar to a pulse or a square wave, which is advantageous to lamp driving, according to the frequency of the first synchronized signal.

Likewise, the lamp brightness signal generator 132 may generate a lamp brightness signal having a signal form similar to a pulse or a square wave, which is advantageous to lamp brightness control, according to the frequency of the second synchronized signal.

Referring to FIGS. 4A and 4B, it can be seen that the lamp driving signal and the lamp brightness signal are synchronized with the horizontal synchronization signal and the vertical synchronization signal, respectively.

According to the present invention, a lamp driving signal and a lamp brightness signal are synchronized with a horizontal synchronization signal and a vertical synchronization signal for driving an image board of an LCD product. Accordingly, waterfall and flicker phenomena can be prevented from occurring in an LCD product.

While the present invention has been shown and described in connection with the exemplary embodiments, it will be apparent to those skilled in the art that modifications and variations can be made without departing from the spirit and scope of the invention as defined by the appended claims.

What is claimed is:

1. A backlight unit for synchronization with an image signal for a liquid crystal display (LCD), the backlight unit comprising:
a synchronization part generating a first synchronized signal synchronized with a horizontal synchronization signal having a preset frequency, and a second synchronized signal synchronized with a vertical synchronization signal having a frequency different from the frequency of the horizontal synchronization signal; and
a signal generation part generating a lamp driving signal for driving a lamp according to the first synchronized signal and a lamp brightness signal for controlling brightness of the lamp according to the second synchronized signal.

2. The backlight unit of claim 1, wherein the synchronization part comprises:
a first synchronizer generating the first synchronized signal synchronized with the frequency of the horizontal synchronization signal;
a frequency converter multiplying and/or dividing the frequency of the vertical synchronization signal; and
a second synchronizer generating the second synchronized signal synchronized with a multiplied and/or divided frequency of the vertical synchronization signal from the frequency converter.

3. The backlight unit of claim 1, wherein the signal generation part comprises:
a lamp driving signal generator converting a signal waveform of the first synchronized signal according to the frequency of the first synchronized signal to generate the lamp driving signal; and
a lamp brightness signal generator converting a signal waveform of the second synchronized signal according to the frequency of the second synchronized signal to generate the lamp brightness signal.

4. The backlight unit of claim 2, wherein the first synchronizer comprises:
a first frequency detector comparing the frequency of the horizontal synchronization signal with a preset reference frequency to detect a frequency difference therebetween;
a first charging pump charging or discharging a voltage according to the frequency difference from the first frequency detector;
a first voltage-current converter converting the charged or discharged voltage from the first charging pump to a current having a preset ratio; and
a first oscillator generating the first synchronized signal having a frequency varied according to the current from the first voltage-current converter.

5. The backlight unit of claim 2, wherein the second synchronizer comprises:
a second frequency detector comparing a multiplied and/or divided frequency of the vertical synchronization signal with a preset reference frequency to detect a frequency difference therebetween;
a second charging pump charging or discharging a voltage according to the frequency difference from the second frequency detector;
a second voltage-current converter converting the charged or discharged voltage from the second charging pump to a current having a preset ratio; and
a second oscillator generating the second synchronized signal having a frequency varied according to the current from the second voltage-current converter.

6. The backlight unit of claim 4, wherein the first voltage-current converter converts the charged or discharged voltage from the first charging pump to a preset current according to a user's selection.

7. The backlight unit of claim 5, wherein the second voltage-current converter converts the charged or discharged voltage from the second charging pump to a preset current according to a user's selection.
